(19) United States
(12) Patent Application Publication
(10) Pub. No.: US 2011/0108125 A1
(43) Pub. Date: May 12, 2011

(54) FLOW SPLITTING DEVICE FOR ANNULAR TWO-PHASE PIPE FLOW

(75) Inventors: May L. Corn, Manchester, CT (US); Muhidin A. Lelic, Londonderry, NH (US); Ravi K. Madabhushi, Longmeadow, MA (US); Marios C. Soteriou, Middletown, CT (US); James A. Wilkinson, North Brookfield, MA (US); Giuliano Amantini, EAst Haven, CT (US)

(73) Assignee: UTC Fire & Security Corporation

(21) Appl. No.: 12/999,871

(22) PCT Filed: Jun. 25, 2008
(86) PCT No.: PCT/US08/68135

§ 371 Date: Dec. 17, 2010

(51) Int. Cl. F15D 1/02; F16L 41/04

(52) U.S. Cl. 137/3; 285/133.11

(57) ABSTRACT

A flow splitting device for use in a two-phase flow distribution network includes a side junction tee having a first conduit and a second conduit opening in flow communication to the first conduit, a flow restriction provided in the first conduit upstream of the opening of the second conduit with the first conduit, and a flow barrier extending into the first conduit at a location in the vicinity of a downstream edge of the opening of the second conduit to the first conduit. The ratio of the liquid phase mass flow to the gas phase mass flow is preserved as the mass flow ratio of liquid to gas to each of the two exit streams is substantially equal to the mass flow ratio of liquid to gas in the two-phase flow received by the flow splitting device.

### FIELD OF THE INVENTION

This invention relates generally to two-phase flow distribution systems. More particularly, this invention relates to improved liquid distribution within the gas flow of a pair of two-phase flow streams discharging from the two outlets of a side junction tee incorporated in a network of distribution pipes.

### BACKGROUND OF THE INVENTION

Pipe distribution networks are used in various applications for conveying a pressurized two-phase flow of liquid carried in a gas stream from a source to a plurality of end points. For example, applications of such pipe distribution networks include, but are not limited to, oil fields where steam is conveyed through a pipe network for oil recovery, natural gas distribution pipelines, cooling networks for nuclear power plants and refrigeration systems, and fire suppression systems. To facilitate distribution of the two-phase flow amongst a plurality of end points, such pipe networks generally incorporate one or more tee junctions.

There are two basic configurations of flow splitting tees that may be installed at such tee junctions. These are the impacting tee, also commonly referred to as a “bull tee”, and the side tee. In the impacting tee, an incoming flow traveling axially along the stem of the tee is split into two flow streams that discharge from the tee through the opposite ends of the head of the tee. Thus, the two flow streams discharging from a bull tee pass out of the head of the tee in opposite directions and orthogonally to the single flow stream entering the bull tee. In a side tee, however, an incoming flow enters a first end of the head of the tee and travels axially along the head of the tee. When this flow encounters the intersection of the head of the side tee with the stem of the side tee, a portion of the flow passes into the stem of the tee and exits therethrough orthogonally to the remainder of the flow which continues to flow axially along and exit through the opposite end of the head of the tee.

In most applications, it is desirable to distribute the two-phase mixture of liquid droplets and gas flowing through the pipe network uniformly throughout the pipe network. Therefore, at each tee junction encountered, the mass flow ratio of liquid to gas in each of the downstream flow streams, that is the streams passing out of the tee junction, should be substantially equal to the mass flow ratio of liquid to gas in the upstream flow stream, that is the single two-phase flow stream entering the tee junction. At tee junctions having a bull tee configuration, for similar boundary conditions at the exits of the tee, a two-phase mixture traversing the bull tee splits at a constant liquid to gas mass ratio because of the geometric symmetry of the bull tee relative to the flow entering the bull tee.

However, at a tee junction configured as a side tee, such geometric symmetry does not exist. Rather a first portion of the incoming two-phase flow must turn through an angle of ninety degrees to exit through a first outlet disposed orthogonally to the inlet of the side tee, while a second portion of the incoming flow merely continues to flow axially through a second outlet disposed axially opposite the inlet to the side tee. As the liquid in the two-phase flow has a greater axial momentum than the gas component of the two-phase flow, a portion of the liquid will slip with respect to the gas flow as the gas flow turns through the ninety degree angle and will instead continue to flow generally axially past the opening to the stem of the side tee. As a result, the mass flow ratio of liquid to gas, also referred to as the liquid to gas mass flow ratio, is not preserved across the side tee junction. Rather, the mass flow ratio of liquid to gas in the two-phase mixture exiting through the first outlet of the side tee orthogonally to the incoming flow will have a lower mass flow ratio of liquid to gas than the liquid to gas mass flow ratio of the two-phase flow entering the side tee, while the mass flow ratio of liquid to gas in the two-phase mixture exiting through the second outlet of the side tee will have a higher mass flow ratio of liquid to gas than the liquid to gas mass flow ratio of the two-phase flow entering the side tee.

For conventional side tees the difference in the respective liquid to gas mass flow ratio between the two exit flow streams is most pronounced when splitting flow in the annular two-phase flow regime. In the annular two-phase flow regime, the liquid phase of the flow tends to concentrate as an annular stream tunneling along the circumferential surface of the pipe about a central core of the carrying gas flowing axially through the pipe. Thus, in annular two-phase flows, the liquid phase is not uniformly distributed with respect to the gaseous phase. This concentration of the liquid phase about a central core of the gas phase characteristic of annular two-phase flow further exaggerates the inherent disparity between the liquid to gas mass flow ratios of the split flow streams exiting the respective outlets of a conventional side tee.

One approach to address the problem of disproportionate liquid-to-gas mass ratio between the exit streams at a side tee junction in a pipeline distribution network is disclosed in U.S. Pat. No. 4,824,614. The device disclosed therein consists of the combination of three components, including a static mixer disposed in the pipe upstream of the tee junction, followed by a static stratifier, also disposed in the pipe upstream of the tee junction that, in turn, is immediately succeeded by a divider wall that extends within the tee. The divider wall functions to separate the flow having passed through the mixing means and the stratifier into a pair of isolated streams for discharge through the two outlets of the tee.

### SUMMARY OF THE INVENTION

A flow splitting device is provided for use in connection with a network of interconnected distribution pipes for splitting a two-phase flow at a junction. The flow splitting device consistently splits an annular two-phase flow of liquid in gas passing through a side tee junction in pipe distribution networks while preserving the liquid to gas mass ratio through the network.

The flow splitting device includes a side junction tee having a first conduit and a second conduit opening in flow communication to the first conduit, a flow restriction provided in the first conduit upstream of the opening of the second conduit to the first conduit, and a flow barrier extending into the first conduit at a location in the vicinity of a downstream edge of the opening of the second conduit to the first conduit. The flow restriction may be positioned upstream of the leading, i.e. upstream, edge of the opening of the second conduit to the first conduit by a distance of up to about two times the inside flow diameter of the first conduit. In an embodiment, the flow restriction is positioned upstream of the flow barrier by a distance of about twice the inside flow diameter of the first conduit.

In an embodiment, the flow restriction may be an annular disc-like member having a central opening therein forming a flow restriction orifice. In an embodiment, the central opening of the annular disc-like member has an orifice diameter equal to about 0.8 of the inside flow diameter of the first conduit.

The flow barrier extends across the first conduit a desired distance to block off a desired amount of the flow area defined by the first conduit so as to optimize the two-phase flow separation. In an embodiment, the flow barrier may extend across the first conduit so as to block off about one half of the flow area defined by the first conduit. In an embodiment, the flow barrier may be formed by a downstream section of an end portion of a downstream pipe extending into the first conduit through a side outlet of the first conduit. In an embodiment, the flow barrier may be a plate member disposed across a portion of the first conduit downstream edge of the side outlet of the first conduit.

In an aspect of the invention, a method is provided for splitting an annular two-phase flow of liquid phase in gas phase into two flows. The method includes the steps of: passing the annular two-phase flow through a side junction tee having an inlet, a thru outlet and a side outlet; causing the liquid phase of the annular two-phase to redisperse into the gas phase downstream of the inlet of the tee and upstream of the side outlet of the tee; capturing a first portion of the two phase flow of the liquid phase redispersed into the gas phase and diverting the first portion to flow out of the side outlet of the tee; and passing an uncaptured second portion of the liquid phase redispersed into the gas phase out of the thru outlet of the tee.

### BRIEF DESCRIPTION OF THE DRAWINGS

The following detailed description of the invention is to be read in connection with the accompanying drawing, wherein:

FIG. 1 is a depiction, partly in schematic and partly in perspective, of an exemplary embodiment of a liquid augmented inerting gas fire suppression system;

FIG. 2 is a perspective illustration of an impacting tee junction;

FIG. 3 is a perspective illustration of a side tee junction;

FIG. 4 is a side elevation view illustrating an annular two-phase flow passing (FIG. 4A) through a horizontal run of pipe and (FIG. 4B) through a vertical run of pipe;

FIG. 5 is a sectioned plan view of an exemplary embodiment of the flow splitting device of the invention disposed in a horizontal orientation;

FIG. 6 is a sectioned plan view of another exemplary embodiment of the flow splitting device of the invention disposed in a horizontal orientation;

FIG. 7 is a perspective view of an exemplary embodiment of the flow restrictor of the flow splitting devices depicted in FIGS. 5 and 6;

FIG. 8 is an elevation view looking downstream through the flow splitting device of FIG. 5 from upstream of the side outlet;

FIG. 9 is a graphical presentation of the actual liquid distribution between the respective outlets of the flow splitting device of the invention disposed in a horizontal orientation relative to the theoretically expected gas distribution at various outlet flow area ratios;

FIG. 10 is a graphical presentation of a comparison of the distribution of liquid between the respective outlets of the flow splitting device of the invention as compared to a conventional side tee for various side tee junction orientations; and

FIG. 11 is a graphical presentation of a Baker flow regime map.

### DETAILED DESCRIPTION OF THE INVENTION

The present invention will be described herein, for the purpose of illustration, but not limitation, with reference to a water augmented gas inerting fire suppression system for use in commercial buildings for extinguishing fires. It is to be understood that the present invention is not limited in application to fire suppression systems, but may also find application in connection with other two-phase flow systems, including, but not limited to, steam based oil recovery systems, natural gas pipelines, cooling fluid networks for refrigeration systems or nuclear power plants, or any two-phase flow system operating in an annular flow regime.

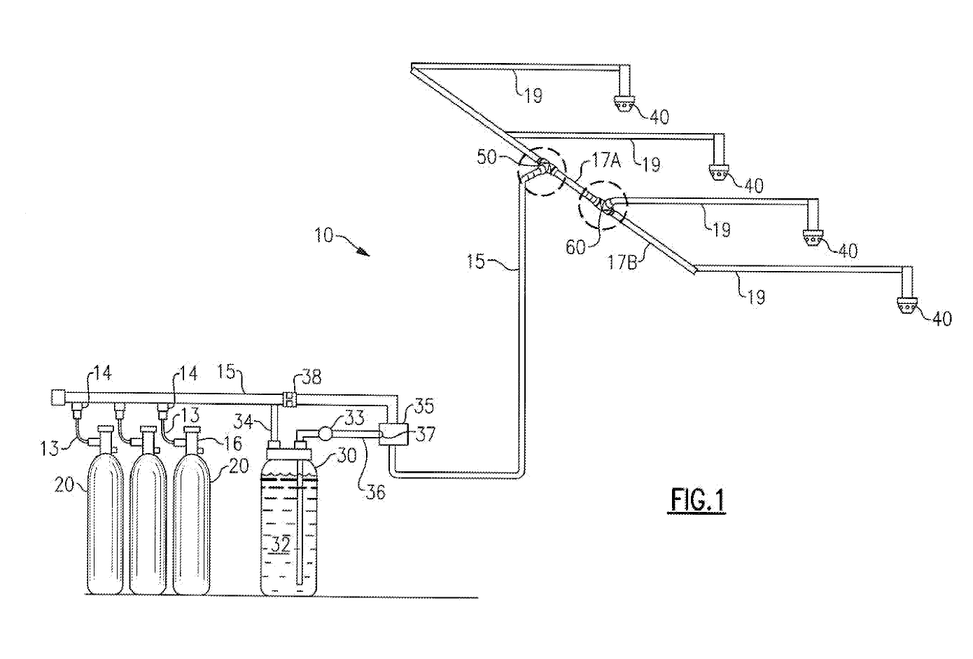

Referring now to FIG. 1, the fire suppression system 10 may include one or more vessels 20 for storing an inerting gas, that is a chemically non-reactive gas, such as nitrogen, argon, neon, helium, or a mixture of two or more of these gases, a liquid storage vessel 30, and at least one discharge device 40 associated with the region to be protected. However, except when the region to be protected is a single rather small room, a plurality of discharge devices 40 would generally be provided in association with the region to be protected, with one or more discharge devices provided per room defined within the protected region.

The inerting gas storage vessels 20 may be connected in parallel arrangement in flow communication with the discharge devices 40, which for example may be spray nozzle assemblies, via an inerting gas distribution network made of a supply pipe 15, an intermediate distribution pipe 17 and a plurality of circuit pipes 19. The inerting gas supply pipe 15 is in fluid flow communication at its terminus with the intermediate distribution pipe 17. Each of the circuit pipes 19 branches off from and is in fluid flow communication with the intermediate distribution pipe 17 and has a terminus disposed within the space to be protected to which a respective one of the spray nozzle assemblies is mounted. When a fire is detected within the space to be protected, inerting gas under pressure within the inerting gas vessels 20 passes therefrom through the supply pipe 15 to and through the intermediate distribution pipe 17 and thence to and through each of the circuit pipes 19, each of which feeds the inerting gas to a respective one of the spray nozzle assemblies 40.

Each of the inerting gas storage vessels 20 has a gas outlet connected via a branch supply line 13 in flow communication with the supply pipe 15. A check valve 14 may be disposed in each branch supply line 13 for allowing the inerting gas to flow from the respective inerting gas storage vessel 20 associated therewith through branch supply line 13 into the inerting gas supply pipe 15, but to prevent flow back into the inerting gas storage vessel. Each of the inerting gas storage vessels 20 may be equipped with an outlet valve 16 to regulate the gas discharge pressure, which is typically less than the storage pressure. For example, the inerting gas may be typically stored within the gas storage vessel 20 at a pressure in the range of 200 to 300 bars, but discharged into the pipe 15 at a pressure in the range of 20 to 50 bars. If desired, the outlet valve 16 may also be designed to control the rate of inerting gas flow from the gas storage vessel 20 associated therewith.

The liquid storage vessel 30 defines an interior volume 32 wherein a supply of fire suppression liquid, such as for example water, is stored. Although the liquid stored within the storage vessel 30 will be referred to herein as water, it is to be understood, however, that other liquids, such as chemical fire suppression agents, may be stored in the storage vessel 30. A gas inlet line 34 establishes flow communication between the inerting gas supply pipe 15 and an upper region of the interior volume 32 of the water storage vessel 30. A water outlet line 36 establishes flow communication between a lower region of the interior volume of the liquid storage vessel 30 and the inerting gas distribution network at a location downstream with respect to the inerting gas flow of the location at which the gas inlet line 34 taps into the inerting gas supply line 15. Additionally, a flow restriction device 38 may be disposed in the inerting gas distribution network at a location between the location upstream thereof at which the gas inlet line 34 taps into the supply line 15 and the location downstream thereof at which the water outlet line 36 opens into the inerting gas distribution network. The flow restriction device 38, which may, for example, comprise a fixed orifice device interdisposed in the inerting gas supply line 15, causes a pressure drop to occur as the inerting gas traverses the flow restriction device 38, whereby a gas pressure differential is established between the upstream location at which the gas inlet line 34 taps into the inerting gas supply pipe 15 and the downstream location at which the water outlet line 36 opens into the inerting gas distribution network.

A spray nozzle 37 may be mounted to the outlet end of the water outlet line 36 to atomize or otherwise produce a mist of water droplets as the water from the supply tank 30 is introduced into the inerting gas flow. In the embodiment of the fire suppression system 10 depicted in FIG. 1, the water outlet line 36 opens into a mixing chamber 35 disposed in the inerting gas supply pipe 15 of the inerting gas distribution network at a location downstream with respect to gas flow of the flow restriction device 38. However, it is to be understood that a defined mixing chamber 35 is not required. Alternatively, the water outlet line 36 may discharge directly into the interior volume defined by the inerting gas supply pipe 15 with the water from the storage vessel 30 passing from the water outlet line 36 through spray nozzle 37 directly into the inerting gas flow passing through the supply pipe. The spray nozzle 37 converts the water into a mist of droplets and sprays the droplets into the flow of inerting gas passing through the mixing chamber 35 or the inerting gas supply pipe 15, thereby forming a two-phase fluid flow which continues through the supply pipe 15 and the remainder of the flow distribution network to the plurality of spray nozzles 40. A flow control device 33 may be disposed in the water outlet line 36 to regulate the amount of water flowing therethrough.

Upon interaction of the high velocity stream of inerting gas with the injected water spray, a two-phase mixture of water droplets entrained in and carried by the inerting gas flow is formed. This two-phase mixture is distributed via the network of distribution pipes to the discharge nozzles that are operatively associated with the region to be protected. The discharge nozzles spread the water mist droplets and inerting gas over a desired area to in effect flood that area with water mist droplets and inerting gas for extinguishing a fire in the protected region.

The inerting gas suppresses fire within the protected region by diluting the oxygen content within the protected region to a lower level and also absorbing heat from the fire. Additionally, the water mist droplets enhance fire suppression by raising the overall heat capacity of the atmosphere within the protected volume. Due to the presence of the water droplets, the two-phase mixture of water mist droplets and inerting gas has a higher overall capacity than the inerting gas alone. Consequently, the two-phase mixture of water mist droplets and inerting gas will more effectively absorb heat from the fire within the protected volume to the point that the temperature of the air within the protected volume drops below a threshold temperature below which combustion can not be sustained, for example below 1500 degrees Kelvin.

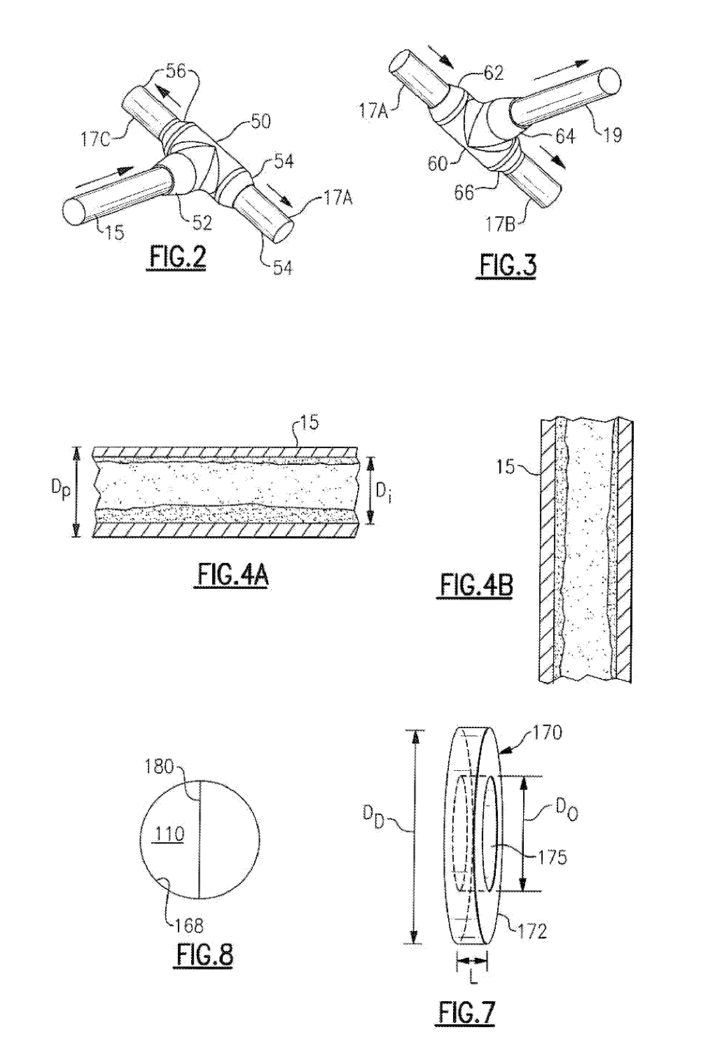

In the depicted exemplary embodiment of the fire suppression system 10, the supply pipe 15 and the intermediate distribution pipe 17 intersect in a T-shaped junction with the supply pipe 15 connected to the stem of the impacting junction tee 50, which forms the inlet leg 52 of the junction tee 50, and segments 17A and 17C of the intermediate distribution pipe 17 connected to the respective ends of the head of the junction tee 50, which form the two outlet legs 54, 56 of the junction tee 50, as illustrated in FIG. 2. The two-phase fluid received from the inerting gas supply pipe 15 through the inlet leg 52 of the junction tee 50 splits into two portions, one portion discharging through the first outlet leg 54 of the junction tee 50 into segment 17A of the intermediate distribution pipe 17 and the other portion discharging through the second outlet leg 56 of the junction tee 50 into segment 17C of the intermediate distribution pipe 17.

Additionally, each of the circuit pipes 19 intersects the intermediate distribution pipe 17 in a T-shaped junction with the upstream segment 17A of the intermediate distribution pipe 17 connected to a first end of the head of the side junction tee 60, which forms the inlet leg 62 of the side junction tee 60, and the downstream segment 17B of the intermediate distribution pipe 17 connected to the other end of the head of the side junction tee 60, which forms outlet leg 66 of the side junction tee 60, and the circuit pipe 19 connected to the stem of the side junction tee 60, which forms outlet leg 64 of the side junction tee 60, as illustrated in FIG. 3. The two-phase fluid received from the upstream segment 17A of the intermediate distribution pipe 17 through the inlet leg 62 of the side junction tee 60 splits into two portions, one portion turning through ninety degrees to discharge through the side outlet leg 64 of the side junction tee 60 into the circuit pipe 19 and the other portion continuing axially to discharge through the end outlet leg 66 of the side junction tee 60 into downstream segment 17B of the intermediate distribution pipe 17. As used throughout with reference to the invention, upstream and downstream are with respect to the flow of the two-phase flow as it passes through the system 10.

Two-phase fluid flow through a pipe will assume one of a number of distinct flow patterns depending upon the pressure and mass flow rates of the liquid and the gas phases. For two-phase flow through a horizontal pipe, it is known that the flow pattern will change as the gas flow rate increases from bubbly flow, to plug flow, to stratified flow, to wavy flow, to slug flow, to annular flow and finally to mist flow. These parameters can be used to predict whether a two-phase flow passing through a particular size pipe will be in the annular flow regime or one of the other aforementioned flow patterns. For example, Mr. Ovid Baker presents a flow regime map in an article he published in Oil and Gas Journal, Volume 53, 1954, at pages 185-195, entitled, “Designing for Simultaneous Flow of Oil and Gas.” The Baker flow regime map presents a graphical plot of G_{G}/λ as the ordinate (y-axis) versus G_{L}λψ/G_{G} as the abscissa (x-axis), where:
G_{G} is the gas mass flow rate per pipe cross-sectional area, and
G_{L} is the liquid mass flow rate per pipe cross-sectional area; both expressed in units of pounds mass per second per square foot;
λ=[(ρ_{G}×ρ_{L})/(ρ_{A}×ρ_{W})]^{1/2}; and
ψ=(σ_{W}/σ_{L})×[(μ_{L}/μ_{W})×(ρ_{W}/ρ_{L})²]^{1/3}
where:
   ρ and μ represent the density and the dynamic viscosity, respectively, of the gas (subscript G) phase of the two phase flow, of the liquid (subscript L) phase of the two phase flow, of air (subscript A) at 20° C. and 1 atmosphere pressure, and of water (subscript W) at 20° C. and 1 atmosphere pressure; and σ represents the surface tension of the liquid phase (subscript L) or of water (subscript W).
      Similarly, for two-phase flow through a vertical pipe, it is known that the flow pattern will change as the gas flow rate increases from bubbly flow, to slug flow, to churn, and then to annular flow.

Given the high pressures, typically ranging from about 20 to about 50 bars, at which the inerting gas may be released into the pipe 15 from the gas storage vessels 20, and the volume of inerting gas needed to establish a fire suppression atmosphere within the protected region, the gas mass flow rate is high enough that the two-phase flow traversing the system pipe network generally assumes an annular flow pattern in a typical inerting gas fire suppression system. For example, in a typical inert gas fire suppression system having a distribution system with a pipe inside diameter of 2 inches (5.08 cm), and operating with line pressures ranging from 20 to 50 bars, the two-phase water and inert gas (Nitrogen) flows would lie well within the annular flow regime 200, designated by the dashed lines, shown on the Baker flow regime map illustrated in FIG. 11, wherein data points A, B, C and D represent exemplary two-phase flows existing upstream of the side tee junction at the following conditions:

| | Mass Fluxes | | Gas | | |
|---|---|---|---|---|---|
| Data | Nitrogen | Water | Pressure | Baker MAP Coordinates | |
| Point | (lbs/sec/ft²) | (lbs/sec/ft²) | (Bars) | Abscissa | Ordinate |
| A | 50.53 | 12.63 | 20 | 1.24 | 11.22 |
| B | 50.53 | 12.63 | 50 | 1.97 | 7.09 |
| C | 60.63 | 15.16 | 20 | 1.24 | 13.46 |
| D | 60.63 | 15.16 | 50 | 1.97 | 8.51 |

In two-phase flow systems operating in the annular flow regime, the water droplets injected into the inerting gas flow coalesce and concentrate as a liquid film flowing along the inner wall of the distribution pipes, thereby forming a tunnel flow about a core flow of inerting gas, such as illustrated in FIG. 4A with respect to two-phase annular flow through a horizontal pipe, and as illustrated in FIG. 4B with respect to two-phase annular flow through a vertical pipe.

As noted previously, in conventional two-phase annular flow systems, because the liquid phase is concentrated in an annular tunnel-like flow along the inside wall of the pipes of the distribution network and because the linear momentum of the liquid phase is substantially greater than the linear momentum of the gas phase, the potential exists for an unequal distribution of the liquid phase to occur between the two-phase flows discharging from their respective two outlets of a side junction tee, resulting in significant deviation in the liquid to gas mass flow ratios of the discharge streams relative to the expected theoretical ratios based on relative outlet flow areas and exit boundary conditions. Applicants have determined that the occurrence of such an unequal distribution of liquid phase between the two outgoing flows may be diminished by causing the liquid phase entering the tee junction to “lift” off the pipe wall into the core gas flow and by capturing and diverting that liquid which, due to its greater linear momentum, tends to slip from the gas flow as the gas flow turns into the side branch leg of the side junction tee.

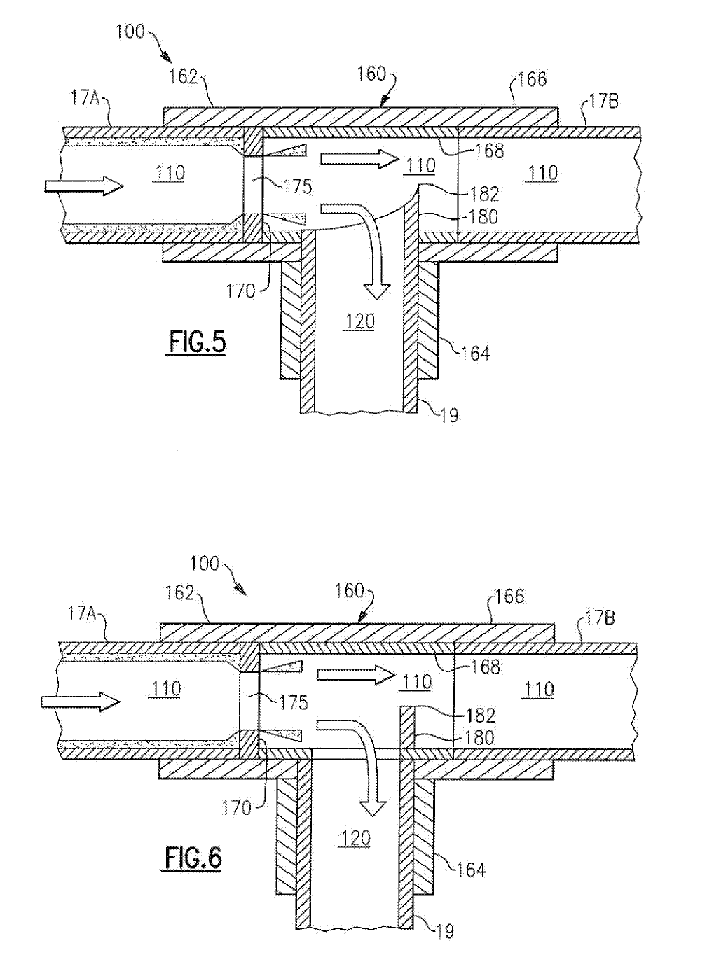

Referring now to FIGS. 5-6, in which like numerals refer to like elements throughout, there is depicted a sectioned plan view of the flow splitting device 100 of the present invention illustrated in a horizontal orientation, that is with all branches of the tee extending horizontally. However, it is to be understood that the flow splitting device may be employed in any orientation. The flow splitting device 100 includes a side junction tee 160, a flow restrictor 170 and a flow barrier 180. The side junction tee 160 defines having a first conduit 110 extending axially through the head of the junction tee 160 and a second conduit 120 orthogonally intersecting the first conduit 110 in flow communication therewith and extending through the stem of the junction tee 160. The side junction tee 160 is installed in the pipe distribution network of the system 10, in the position of the side tee 60 shown in FIG. 1, with the upstream pipe section 17A received into the upstream leg 162 of the head of the side junction tee 160, with the downstream pipe section 17B received into the downstream leg 166 of the head of the side junction tee 160, and with the inlet leg of the pipe 19 received into the stem 164 of the side junction tee 160. A sleeve 168 may be inserted into the side junction tee to provide a stop for limiting the distance that the ends of pipes 17A and 17B may be inserted into the head of the side junction tee 160 so that the ends of those pipes do not block the opening to the second conduit 120. An opening is provided in the sleeve 168 that is commensurate in size to the opening from the first conduit 110 to the second conduit 120 and is aligned with that opening when the sleeve 168 is inserted into the side junction tee 160. Rather than being a separate insertion into the side junction tee, the sleeve 168 may be formed integral with the side junction tee 160.

The flow restrictor 170 is disposed in the first conduit 110 upstream of the side outlet opening into the second conduit 120. The flow barrier 180 extends into the first conduit 110 at a location in the vicinity of a downstream edge of the side outlet opening into the second conduit 120. Both the flow restrictor 170 and the flow barrier 180 are confined within the tee, thereby rendering the flow splitting device 160 an all-in-one device. In an embodiment, the flow restrictor 170 may be positioned within about two (2) conduit inside diameters of the leading edge 121 of the inlet opening to the second conduit 120. Placement of the flow restrictor 170 much beyond two (2) conduit inside diameters upstream of the flow barrier 180, such as for example within the pipe 17A outside of and upstream of the side junction tee 160, facilitates the reattachment of the liquid phase to the wall of the pipe 17A or the first conduit 110 downstream of the flow restrictor 170 and upstream of the flow barrier 180. Any such reattachment of the liquid phase would reduce the effectiveness of the flow splitting device 100 in preserving mass flow ratio.

The flow restrictor 170 should be sized according to the particular flow distribution system in which it is installed. If a high pressure drop can be tolerated, the flow restrictor 170 may comprise an atomizing nozzle. Generally, it is desirable that the flow restrictor 170 impart a low or even minimal pressure drop to the flow traversing the flow restrictor 170. In applications where a low pressure drop is desired, the flow restrictor 170 may comprise a fixed flow area orifice device as depicted in FIGS. 5-7.

Referring now to FIG. 7, in particular, in the exemplary embodiment depicted therein, the flow restrictor 170 may be an annular disc-like member 172 having an outer diameter, D_{D}, commensurate with the outer diameter, D_{P}, of the pipe 17A inserted into the inlet leg 162 of the tee 160 and having a thickness, L. The annular disc-like member 172 defines a central circular opening 175 passing therethrough and defining a flow restricting orifice having an orifice diameter, D_{O}. The flow restrictor 170 functions as an impediment to the further advancement of the annular flow of the liquid phase of the two-phase annular flow, which enters the side junction tee 160 flowing along the inside wall. When the liquid flowing along the wall encounters the disc-like member 172, the liquid must pass through the central opening 175. As a result, the flow restrictor 170 in effect lifts the liquid off the wall and back into the inerting gas flow passing through the central opening 175 as a spray of liquid droplets uniformly distributed in the flow.

As noted previously, the flow restrictor 170 imparts a pressure drop to the flow passing therethrough. Generally, it is desirable to minimize that pressure drop without destroying the effectiveness of the flow restrictor 170 in causing the liquid phase of the two phase flow to lift off the wall. In the case of the annular disc-like member 172, if the central opening 175 is too small, the pressure drop experienced by the gas phase in passing therethrough will be excessive. Conversely, if the central opening 175 is too large, although the pressure drop experienced by the gas phase in passing therethrough will be reduced, the incoming liquid will flood over the rim of the disc-like member 172 and simply continue to flow along the wall defining the first conduit 110 downstream of the member 172 rather than being re-introduced into the gas flow passing through the central opening 175. The diameter, D_{O}, of the central opening 175 in the annular disc-like member 172 is determined for any particular application from the parameters contributing to the existence of annular two-phase flow, such as the pipe inside flow diameter, the gas flow rate, the liquid flow rate, the respective liquid and gas densities, and the surface tension and dynamic viscosity of the liquid, as well as pressure drop limitations. Generally, the diameter, D_{O}, of the central opening 175 may be sized such that the film thickness of the liquid in the annular flow flowing along the wall is less than one half of the quantity D_{D}-D_{O}.

The thickness, L, of the flow restrictor 170, may vary as desired within constraints of the space available with the upstream leg 162 of the flow splitting tee 160. Thinner members result in a relatively lower pressure drop experienced by the flow passing through the central opening 175 in the flow restrictor 170, while thicker members result in a relatively larger pressure drop experienced by the flow passing through the central opening 175 in the flow restrictor 170. In an exemplary embodiment of the flow splitting tee 160 for example, for purposes of illustration, but not limitation, if the flow splitting tee 160 is installed as a side junction tee 60 in a pipe distribution network wherein the upstream pipe 17A to which the flow splitting tee 160 is connected has a nominal outside pipe diameter of 0.5 inches and inside pipe diameter of 0.41 inches, the annular disc-like member 172 may have a thickness, L, of about 0.08 inches, a nominal outer diameter, D_{D}, of 0.41 inches, an orifice diameter, D_{O}, of about 0.34 inches, which provides a ratio of orifice diameter, D_{O}, to inside flow diameter, Dᵢ, of the first conduit 110 of about 0.8.

As noted previously, the flow barrier 180 extends into the first conduit 100 at a location adjacent the downstream edge of the opening from the first conduit 110 into the second conduit 120. The positioning of the flow barrier 180 may be adjusted to increase or decrease the penetration of the flow barrier 180 into the first conduit 110 as desired. Those skilled in the art will understand that the optimal extension of the flow barrier 180 into the first conduit 110 will vary from application to application and that adjustment of the extent of penetration on a case by case basis is within the knowledge of a person of ordinary skill in the art. Referring now to FIGS. 5, 6 and 8, in particular, the flow barrier 180 may extended across a lower portion of the first conduit 110, for example to block off up to about one-half one the flow area of the first conduit 110. The flow barrier 180 may comprise an end portion of the pipe 19 extending into the first conduit 110 such as depicted FIG. 5. In this embodiment, the end portion 119 of pipe 19 is cut at an angle before the pipe is inserted into the side arm 164 to form a scoop-like structure. If the flow barrier 180 is formed by the end of the pipe 19 per se, adjustment of the extent of penetration of the end of the pipe 19 into the first conduit 110 may be accomplished by simply inserting further or slightly withdrawing the end of the pipe 19 before securing the pipe 19 to the side arm 164 of the flow splitting device 160. However, in an embodiment, the flow barrier 180 may simply comprise a blocking plate in the form of a segment of a circle that is disposed downstream of the inlet to the thru arm 166. For example, the blocking plate may be positioned in the first conduit 110 immediately adjacent the downstream edge of the side opening from the first conduit 110 into the second conduit 120, such as depicted in FIG. 6.

The flow barrier presents a physical barrier to any liquid that may, due to its relatively higher linear momentum as compared to the momentum of the gas phase, slip out of the gas flowing through the first conduit 110 as the gas flow turns through ninety degrees to enter the second conduit 120. The presence of the flow barrier 180 prevents this portion of the liquid flow from continuing to flow past and over the opening to the second conduit 120 and subsequently discharging through the downstream outlet of the side junction tee. Rather, this portion of the liquid flow impinges upon the flow barrier 180 and is reflected back into the first portion of the two-phase flow turning into the second conduit 120 to exit through the side outlet of the side junction tee. A second portion of the two-phase flow simply flows axially through the first conduit 110 past the distal extent 182 of the flow barrier 180 to exit through the downstream outlet of the side junction tee.

In the exemplary embodiments of the flow splitting device 100 illustrated in FIGS. 5 and 6, the flow areas of the two outlets of the side junction tee 160 are equal. That is, each of the thru outlet, i.e. the outlet from the first flow conduit 110, and the side outlet, i.e. the outlet from the second flow conduit 120, defines 50% of the total exit flow area from the side tee junction. A flow splitting device 100 of such configuration would be used as a side junction tee where it is desired to split the incoming two-phase flow into two discharge flows having essentially the same liquid to gas mass flow ratio as the liquid to gas mass flow ratio of the incoming two-phase flow. With the flow splitting device 100 of the invention so configured, approximately one-half of the liquid phase component and one-half of the gas phase component of the incoming two-phase flow would be discharged through each one of the outlet of the thru arm 166 and the outlet of the side arm 164 of the side junction tee. As used herein, liquid mass flow refers to the mass of liquid per unit time flowing through a respective conduit and gas mass flow refers to the mass of gas per unit time flowing through that respective conduit. The term conduit may refer to any flow passageway, whether defined by a pipe, a sleeve or other tubular member.

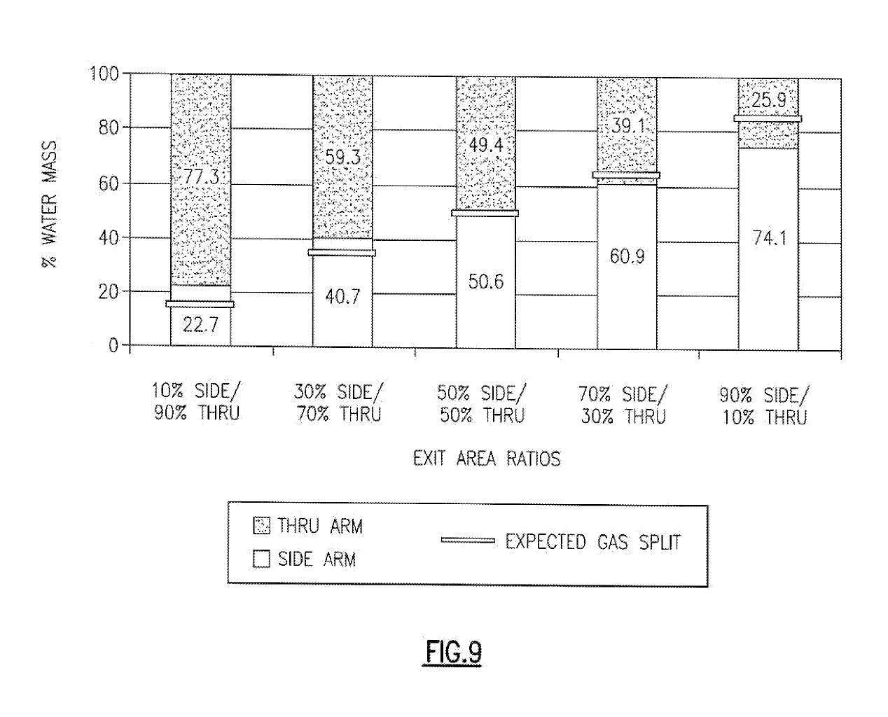

Of course, the flow splitting device 100 may be configured to provide a flow split between the outlet of the side arm 164 and the outlet of the thru arm 166 other than a substantially 50%/50% split by providing different flow areas for the respective outlets. In theory, the gas phase of the two-phase flow will split in proportion to the ratio of the respective exit flow areas. Referring now to FIG. 9, there is depicted therein test results showing the percentage of water mass A discharging through the outlet of the thru arm 166 and the percentage of water mass B discharging through the outlet of the side arm 164 for various ratios of the flow area of the outlet of the side arm 164 to the outlet of the thru arm 166 for a flow splitting device in accord with the invention disposed in a horizontal orientation. Additionally, FIG. 9 illustrates the effectiveness of the flow splitting device 100 for splitting an incoming two-phase flow into two discharge flows having liquid mass ratios that are approximately equal to the gas mass ratios, based on the theoretically expected split of the gas phase, over a wide range of flow area ratios between the respective outlets to the side junction tee. These results confirm that the liquid to gas mass ratio is substantially preserved in the flow splitting device 100 of the invention for flow area splits up to a 20%/80% flow area ratio. Beyond that flow area ratio, the effectiveness of the flow splitting device 100 in preserving mass flow ratio decreases. For example, the flow splitting device 100 would not be as effective when applied to a flow area split at a 10%/90% flow area ratio.

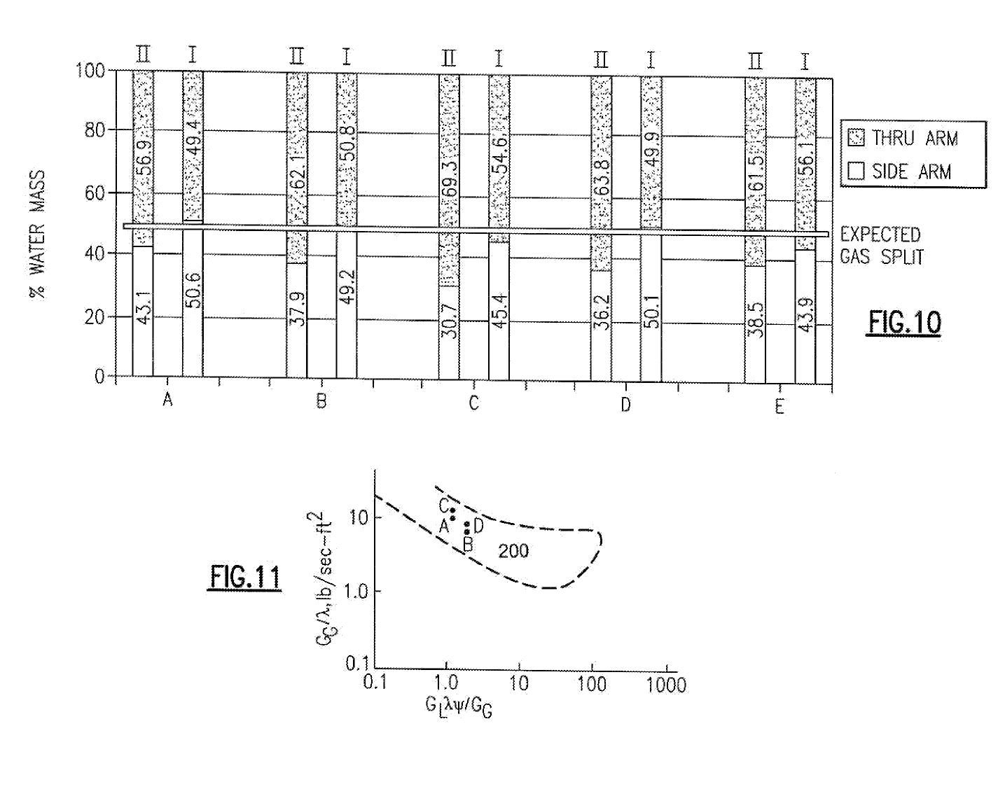

As noted previously, the flow splitting device 100 is not limited to use in only in the horizontal orientation, as depicted in FIGS. 5 and 6 solely for illustration, wherein flow through both the thru conduit 110 and the side conduit 120 is horizontal. The flow splitting device may be used in any orientation including, but not limited to the following orientations depicted in FIG. 10:
Orientation A—thru conduit 110 horizontal, side conduit 120 horizontal;
Orientation B—thru conduit 110 horizontal, side conduit 120 vertical down;
Orientation C—thru conduit 110 horizontal, side conduit 120 vertical up;
Orientation D—thru conduit 110 vertical up, side conduit 120 horizontal;
Orientation E—thru conduit 110 vertical down, side conduit 120 horizontal.

Referring now to FIG. 10, there is depicted, for each of the orientations A-E as described above, a comparison of the water mass flows discharging through the thru outlet and the side outlet, respectively, from test results of a flow splitting device 100 in accord with the invention (columns I) versus a conventional side junction tee (columns II). Unlike the flow splitting device 100, the conventional side junction tee did not include a flow restrictor 170 or a flow barrier 180. In each orientation, the flow areas of the thru outlet and the side outlet were equal for both the flow splitting device 100 and the conventional tee. In all cases, the water flow mass is presented as a percentage of the water mass in the incoming two-phase flow. As seen in FIG. 10, in all orientations, the actual water mass flow split for the flow splitting device 100 was nearly equal to the theoretical expected gas phase split of 50%/50% and substantially closer to the theoretical expected gas phase split, in all orientations, than the water mass percentages associated with the conventional side junction tee.

Additionally, the flow splitting device 100 is compact, simple and inexpensive to produce and implement, and imparts a low pressure loss to the flow passing through the side tee junction.

Although the present invention has been described with reference to the exemplary embodiments depicted, it will be recognized by those skilled in the art that various modifications may be made without departing from the spirit and scope of the invention. Those skilled in the art will also recognize the equivalents that may be substituted for elements described with reference to the exemplary embodiments disclosed herein without departing from the scope of the present invention. Therefore, it is intended that the present disclosure not be limited to the particular embodiment(s) disclosed as, but that the disclosure will include all embodiments falling within the scope of the appended claims.

1. A flow splitting device for use in a two-phase flow distribution network, comprising:
a side junction tee having a first conduit and a second conduit opening in flow communication to said first conduit;
a flow restriction provided in said first conduit upstream of the opening of said second conduit to said first conduit; and
a flow barrier extending into said first conduit at a location in the vicinity of a downstream edge of the opening of said second conduit to said first conduit.

2. The flow splitting device as recited in claim 1 wherein said flow restriction device comprises an annular disc-like member having a central opening therein forming a flow restriction orifice.

3. The flow splitting device as recited in claim 1 wherein said flow barrier extends across said first conduit so as to block off about one half of a flow area defined by said first conduit.

4. A flow splitting device for use in a pipe network for distributing a two-phase flow, said flow splitting device including a side junction tee having a head and a stem orthogonally intersecting said head in a generally T-shaped configuration, said head having an inlet end mounted to an upstream pipe of said pipe network and an outlet end mounted to a first downstream pipe of the pipe network and said stem mounted to a second downstream pipe of the pipe network, said tee defining a first conduit for receiving the two-phase flow from the upstream pipe and having a thru outlet in flow communication with the first downstream pipe and a side outlet in flow communication with the second downstream pipe, said first conduit having an inside flow diameter, said flow splitting device characterized by:
a flow barrier extending into said first conduit at a location in the vicinity of a downstream edge of the side outlet of said first conduit; and
a flow restriction provided in said first conduit upstream of a leading edge of the side outlet of said first conduit.

5. The flow splitting device as recited in claim 4 wherein said flow restriction is positioned in said first conduit upstream of the leading edge of the side outlet of said first conduit by a distance of up to about two times the inside flow diameter of said first conduit.

6. The flow splitting device as recited in claim 4 wherein said flow restriction device comprises an annular disc-like member having a central opening therein forming a flow restriction orifice.

7. The flow splitting device as recited in claim 6 wherein the central opening of said annular disc-like member has an orifice diameter equal to about 0.8 of the inside flow diameter.

8. The flow splitting device as recited in claim 4 wherein said flow barrier extends across said first conduit so as to block off about one half of a flow area defined by said first conduit.

9. The flow splitting device as recited in claim 4 wherein said flow barrier comprises a section of an end portion of said second downstream pipe received in said outlet and extending into said first conduit.

10. The flow splitting device as recited in claim 4 wherein said flow barrier comprises a plate member disposed across a portion of said first conduit adjacent the downstream edge of the side outlet of said first conduit.

11. A method for splitting an annular two-phase flow of liquid phase in gas phase into two flows, comprising the steps of:
passing the annular two-phase flow through a side junction tee having an inlet, a thru outlet and a side outlet;
causing the liquid phase of the annular two-phase to redisperse into the gas phase downstream of the inlet of the tee and upstream of the side outlet of the tee; and capturing a first portion of the two phase flow of the liquid phase redispersed into the gas phase and diverting said first portion to flow out of the side outlet of the tee; and
passing an uncaptured second portion of the liquid phase redispersed into the gas phase out of the thru outlet of the tee.

12. The method as recited in claim 11 wherein the annular two-phase flow received through the inlet of the tee has a first mass flow ratio of liquid phase to gas phase, the first portion of the two-phase flow passing out of the side outlet of the tee has a second mass flow ratio of liquid phase to gas phase and the second portion of the two-phase flow passing out of the thru outlet of the tee has a third mass ratio of liquid phase to gas phase, both the second flow mass ratio and the third mass flow ratio being approximately equal to the first mass flow ratio.
